(19) United States
(12) Patent Application Publication
(10) Pub. No.: US 2022/0101860 A1
(43) Pub. Date: Mar. 31, 2022

(54) AUTOMATED SPEECH GENERATION BASED ON DEVICE FEED

(71) Applicant: KYNDRYL, INC., NEW YORK, NY (US)

(72) Inventors: Sergio Varga, Campinas (BR); Sarbajit K. Rakshit, Kolkata (IN); Daniela Trevisan, Porto Alegre (BR)

(21) Appl. No.: 17/035,736

(22) Filed: Sep. 29, 2020

(51) Int. Cl. G10L 17/22; G10L 17/04; G06N 20/00

(52) U.S. Cl. CPC G10L 17/22; G06N 20/00; G10L 17/04

(57) ABSTRACT

Computer-generated speech based on a device feed includes generating a corpus for robotic use by receiving first information representative of a user's speech in different environments at different times and second information representative of environmental conditions of different locations at the different times. The first and second information of corresponding different environments and different locations for each of the different times is combined with third information received from external data sources. A plurality of annotated combined datasets including the first information, the second information, and the third information is generated for each of the different times in a repository. The plurality of annotated combined datasets is correlated to create training data that is subsequently processed using a predetermined machine learning model. A correlation among spoken tone associated with a contextual situation based on skills of the user is identified in the training data and used to update the corpus.

### BACKGROUND

The present invention generally relates to the field of artificial intelligence (AI), and more particularly to a method, system and computer program product for generating a speech according to a surrounding context determined using internet-of-things (IoT) devices.

Humans have an innate awareness of their surroundings, and generally look for environments with certain attributes. Particularly, environments that can provide feelings of safety and security including physical and psychological comfort. Certain conditions of the surrounding environment can have a positive or negative impact on human behavior. For instance, environmental conditions can influence people's mood and emotions, facilitate or discourage interactions among people, and influence people's behavior and motivation to act.

### SUMMARY

Shortcomings of the prior art are overcome and additional advantages are provided through the provision of a computer-implemented method for speech generation that includes generating a corpus for robotic use by receiving first information representative of a user's speech in different environments at different times, receiving second information representative of environmental conditions of different locations associated with the user at the different times, combining the first information and the second information of corresponding different environments and different locations for each of the different times, and in response to receiving third information from external data sources, generating a plurality of annotated combined datasets including the first information, the second information, and the third information for each of the different times in a repository. The plurality of annotated combined datasets is correlated to create training data that is subsequently processed using a predetermined machine learning model. A correlation among spoken tone associated with a contextual situation based on skills of the user is identified in the training data and used to update the corpus.

Another embodiment of the present disclosure provides a computer program product for automated speech generation, based on the method described above.

Another embodiment of the present disclosure provides a computer system for automated speech generation, based on the method described above.

### BRIEF DESCRIPTION OF THE DRAWINGS

The following detailed description, given by way of example and not intended to limit the invention solely thereto, will best be appreciated in conjunction with the accompanying drawings, in which:

FIG. 1 is a block diagram illustrating a networked computer environment, according to an embodiment of the present disclosure;

FIG. 2 depicts a system for computer-generated speech, according to an embodiment of the present disclosure;

FIGS. 3A-3B depicts a flowchart illustrating the steps of a computer-implemented method for speech generation based on a device feed, according to an embodiment of the present disclosure;

FIG. 3C depicts a flowchart illustrating an example implementation of the computer-implemented method for speech generation of FIGS. 3A-3B, according to an embodiment of the present disclosure;

FIG. 4 is a block diagram of internal and external components of a computer system, according to an embodiment of the present disclosure;

FIG. 5 is a block diagram of an illustrative cloud computing environment, according to an embodiment of the present disclosure; and

FIG. 6 is a block diagram of functional layers of the illustrative cloud computing environment of FIG. 5, according to an embodiment of the present disclosure.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Human behavior is determined by the environment in which it takes place. Business and organizations are aware of this and try to provide people with an atmosphere that creates a positive experience and offers comfort, safety, and entertainment.

The effect of the surrounding environment on people's mood may be reflected on their tone of voice, vocal texture, facial expressions, gestures, and the like. Particularly, a person's way of speak can say a lot about the surrounding environment. For example, a noisy, busy office might cause a person to raise his/her voice when speaking, while a bright, quiet room may cause feelings of peace and tranquility resulting in a quiet speaking voice. In some instances, hearing a calm and peaceful voice can be reassuring for someone during a difficult situation, or adjusting a room temperature to a preferred value can help reducing stress in some people.

Current artificial intelligence (AI) systems use emotion recognition technology to replicate human-like speech. Many gadgets and robotic systems are built with this technology producing a new level of human-like emphasis and inflection. However, these systems do not consider the influence of the surrounding environment on people's speech or the level of skills of the person the system is interacting with. Internet-of-things (IoT) devices can provide important information regarding environmental conditions surrounding a person, which in turn may serve to obtain clues about certain behaviors including speech variations and emotions.

Embodiments of the present invention provide a method, system, and computer program product for generating human-like speech based on information received from surrounding device feeds. The following described exemplary embodiments provide a system, method, and computer program product to, among other things, simulate human-like speech based on historical data corresponding to surrounding environmental parameters and their influence on a person's voice tone, texture, and emotions. Embodiments of the present disclosure may allow robotic systems to reproduce human-like speech that matches a surrounding context of a user and user's persona determined from available IoT devices.

Thus, the present embodiments have the capacity to improve the technical field of artificial intelligence by creating a knowledge base of possible voice tones and textures representative of various human emotions at different times and places that can be used by robotic systems to reproduce human-like speech that matches a current surrounding context and user's persona. For instance, embodiments of the present disclosure, can be implemented in a robotic system performing a rescue operation, the robotic system is capable of collecting information from IoT devices available in the environment surrounding the person to be rescued, based on the collected data and the knowledge base, the robotic system analyzes the current situation and generates human-like speech that best matches the current context of the person. The robotic system may be capable, by using the knowledge base, of simulating a speech tone or texture according to the user's persona and surroundings.

Accordingly, by obtaining first information representative of human interactions including speech and behavior in different environments and at different times, and obtaining second information representative of different locations and environments and at different times from surrounding devices, the first and second information can be combined for each of the different times to generate a plurality of annotated combined datasets that can be stored in a repository (i.e., knowledge base) and correlated to create training data to train a predetermined machine learning model. The training data can be analyzed to identify a correlation among spoken tone associated with a contextual situation based on skills of a user and how surrounding influencing factors change the spoken tone and emotion of the user, and based on the correlation, generate a corpus for robotic use. In some embodiments, third information from external data sources including recorded speech and virtual reality systems can be used, in addition to the first and second information from IoT devices, to generate the plurality of combined datasets.

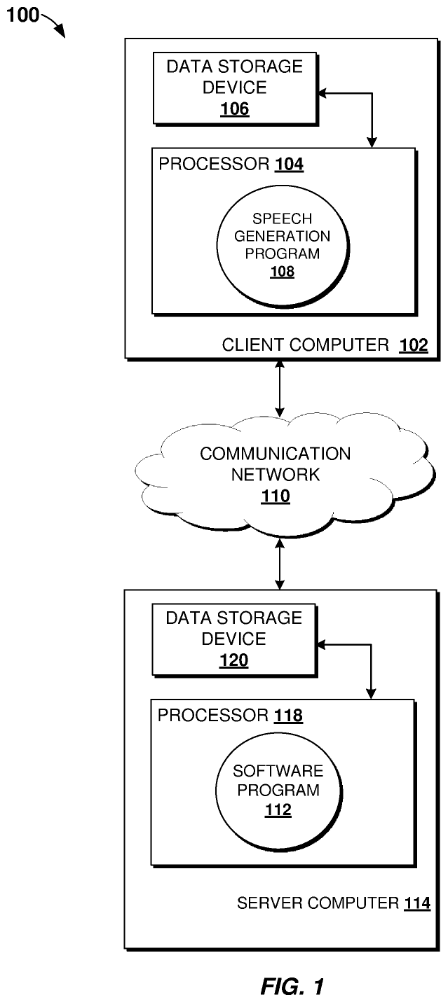

The proposed embodiments are applicable to different situations. For example, when a robot is sent to a particular surrounding to perform spoken communication, the robot can use available IoT data to identify a context of that particular surrounding, types of activity to be performed, and select skills and persona to perform similar spoken content. The robot can then generate speech using the corpus for a selected persona in the context of that particular surrounding, as will be described in detailed below with reference to FIGS. 1-6. Additionally, if IoT devices are not available in the particular surrounding the robot can deploy a plurality of mobile sensors to capture data for speech generation.

Referring now to FIG. 1, an exemplary networked computer environment 100 is depicted, according to an embodiment of the present disclosure. FIG. 1 provides only an illustration of one embodiment and does not imply any limitations with regard to the environments in which different embodiments may be implemented. Many modifications to the depicted environment may be made by those skilled in the art without departing from the scope of the invention, as recited by the claims.

The networked computer environment 100 may include a client computer 102 and a communication network 110. The client computer 102 may include a data storage device 106 a and a processor 104 that is enabled to run a speech generation program 108. Client computer 102 may be, for example, a mobile device, a telephone (including smartphones), a personal digital assistant, a netbook, a laptop computer, a tablet computer, a desktop computer, or any type of computing devices capable of accessing a network. According to an embodiment, the client computer 102 may include various robotic systems furnished with speech-recognition and dialog capabilities.

The networked computer environment 100 may also include a server computer 114 with a data storage device 120 and a processor 118 that is enabled to run a software program 112. In some embodiments, server computer 114 may be a resource management server, a web server or any other electronic device capable of receiving and sending data. In another embodiment, server computer 114 may represent a server computing system utilizing multiple computers as a server system, such as in a cloud computing environment.

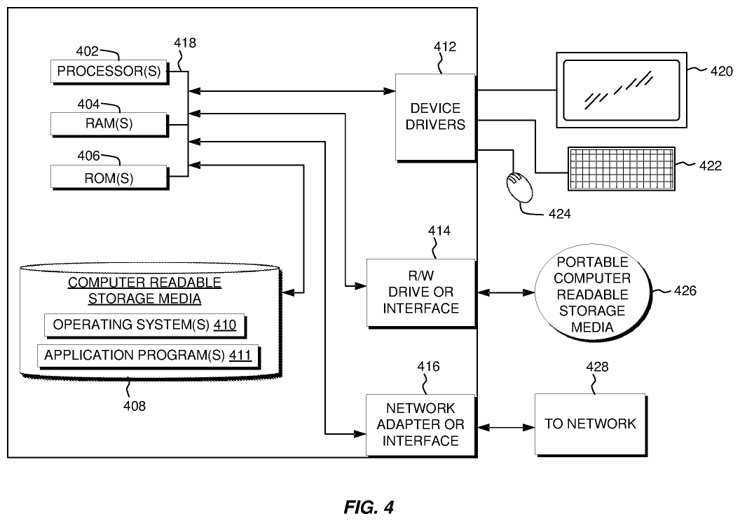

The speech generation program 108 running on client computer 102 may communicate with the software program 112 running on server computer 114 via the communication network 110. As will be discussed with reference to FIG. 4, client computer 102 and server computer 114 may include internal components and external components.

The networked computer environment 100 may include a plurality of client computers 102 and server computers 114, only one of which is shown. The communication network 110 may include various types of communication networks, such as a local area network (LAN), a wide area network (WAN), such as the Internet, the public switched telephone network (PSTN), a cellular or mobile data network (e.g., wireless Internet provided by a third or fourth generation of mobile phone mobile communication), a private branch exchange (PBX), any combination thereof, or any combination of connections and protocols that will support communications between client computer 102 and server computer 114, in accordance with embodiments of the present disclosure. The communication network 110 may include wired, wireless or fiber optic connections. As known by those skilled in the art, the networked computer environment 100 may include additional computing devices, servers or other devices not shown.

Plural instances may be provided for components, operations, or structures described herein as a single instance. Boundaries between various components, operations, and data stores are somewhat arbitrary, and particular operations are illustrated in the context of specific illustrative configurations. Other allocations of functionality are envisioned and may fall within the scope of the present invention. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the present invention.

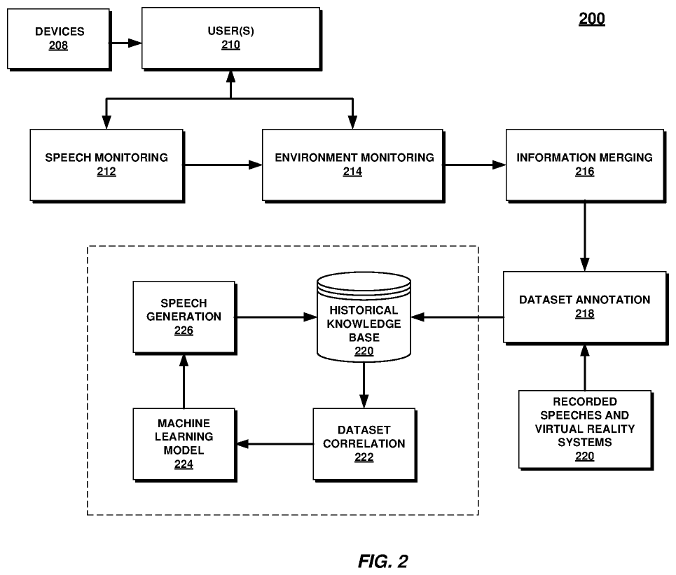

Referring now to FIG. 2, a system 200 for speech generation based on a device feed is shown, according to an embodiment of the present disclosure.

In this embodiment, a speech monitoring engine 212 collects information from a plurality of devices 208 associated with one or more users 210 (hereinafter “users”). The plurality of devices 208 may include IoT devices equipped with sensors capable of identifying a tone of voice and/or texture of the users 210 representative of different emotions and human interaction between two or more users 210 at different times and different locations. The sensors may include, for example, sound sensors, movement sensors, camera, ultrasound feed, and any known sensor device capable of providing location-specific information (e.g., location boundaries, surrounding area, etc.) regarding the users 210. In some embodiments, the sensors may be integrated in any smart IoT device with voice recognition capabilities surrounding and/or wore by the users 210. It should be noted that any device capable of performing voice recognition can be used by the speech monitoring engine 212 to collect information regarding user's speech.

It should be noted that any user data collection is done with user consent via an opt-in and opt-out feature. As known by those skilled in the art, an opt-in and opt-out feature generally relates to methods by which the user can modify a participating status (i.e., accept or reject the data collection). In some embodiments, the opt-in and opt-out feature can include a software application(s) available, for example, in the plurality of devices 208. Additionally, the user can choose to stop having his/her information being collected or used. In some embodiments, the user can be notified each time data is being collected. The collected data is envisioned to be secured and not shared with anyone without user's consent. The user can stop the data collection at any time.

A contextual situation of the users 210 may also be determined via the sensors in the plurality of devices 208, the contextual information may include, for example, weather information, a medical condition of the users 210, an emergency situation, a rescue operation, etc. Also, in addition to the contextual situation, a level of skills, persona, and health condition of the users 210 can be determined based on the information collected from the available sensors.

The speech monitoring engine 212 may use spoken content analysis for identifying a tone, spoken texture, and an emotion in the spoken content or dialog between the users 210. Specifically, natural language processing (NLP) techniques are used to identify how the users 210 narrate the spoken content (e.g., explained properly, could not explain, took a long time to explain, etc.). By analyzing the spoken content from human interaction and IoT feed (i.e., data from available sensors) the contextual situation as well as a critically factor of the situation can be identified.

Similar to the speech monitoring engine 212, an environment monitoring engine 214, collects information from the plurality of devices 208 representative of different parameters associated with environmental conditions surrounding a (current) location of the users 210 at different times. Embodiments of the present disclosure may use IoT devices fitted within the users' location such as a smart thermostat, a home assistance, and the like to determine current environmental parameters surrounding the users 210 (e.g., room temperature, noise level, etc.).

The data collected by the speech monitoring engine 212 and the environment monitoring engine 214 is received by an information merging engine 216, in which the collected information is combined and analyzed to determine a correlation between different environmental parameters, surrounding context, and human interactions on generated speech and behavior. The analyzed information is annotated and classified in different datasets according to the determined correlation by a dataset annotation engine 218, and then stored in a repository of information, i.e., historical knowledge base 220. The historical knowledge base 220 includes a knowledge corpus representative of human speech in various contextual situations. In some embodiments, the dataset annotation engine 218 may receive additional information from external data sources including virtual reality systems, previously recorded speeches, crowdsource data, and data provided by the users 210 that can be integrated to the annotated datasets to enrich or expand the historical knowledge base 220.

The combined annotated datasets from the historical knowledge base 220 are correlated by a dataset correlation engine 222 to create training data that can be used to train a machine learning model 224 according to which the speech generation engine 226 simulates a speech that best matches current environmental parameters, persona, and surrounding context of the users 210. The system 200 is capable of determining a user's persona and level of skills for a particular situation and generate a speech according to the determined persona and level of skills.

For example, in a specific contextual situation, the system 200 can determine whether the speech of a person (e.g., user 210) matches that of an expert or a novice for that specific contextual situation, and generate the most appropriate response. In some embodiments, the system 200 is capable of identifying the combination of skills required by a user 210 to perform an activity in the determined contextual situation (e.g., an emergency or rescue operation), and take the corresponding actions. More particularly, in a contextual situation in which human skills are required to perform an activity together with a robotic system, proper spoken communication can be performed by the user 210 with a remote system via the robotic system. In situations in which the user 210 cannot perform the activity and/or speak to the robotic system, then the robotic system will be analyzing the contextual situation and IoT feed of the surrounding and accordingly be identifying what types of skills and persona are required for the human to perform the activity in the surrounding.

As known by those skilled in the art, machine learning is a form of artificial intelligence that enables a system to learn from data rather than through explicit programming. As the algorithms ingest training data, it is then possible to produce more precise models based on that data. A machine-learning model is the output generated when a machine-learning algorithm is trained with data. After training, the model is provided with an input and an output will be given to user(s). For example, a predictive algorithm will create a predictive model. Then, when users provide the predictive model with data, they will receive a prediction based on the data that trained the model. The process of training machine-learning algorithms typically requires large amounts of data. Depending on the context, data availability for training machine-learning algorithms can be limited or scarce.

It should be noted that the system 200 performs historical learning of the collected speech data and IoT feed to identify: a) a correlation between spoken tone and texture for any contextual situation based on user's skills, b) an influence of surrounding environmental factors on the spoken tone and texture, and c) an influence of the surrounding environmental factors on user's emotions, and the corresponding effect of those emotions on spoken texture and tone.

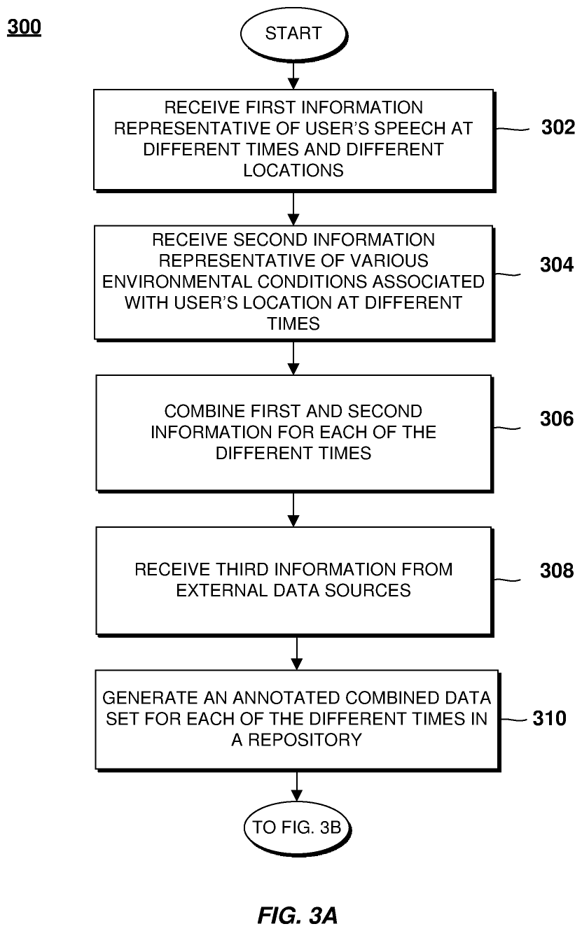

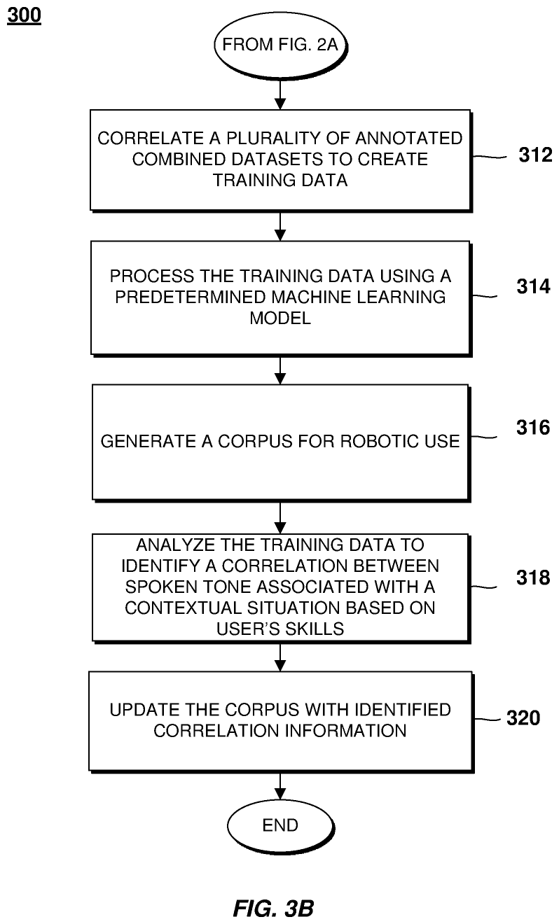

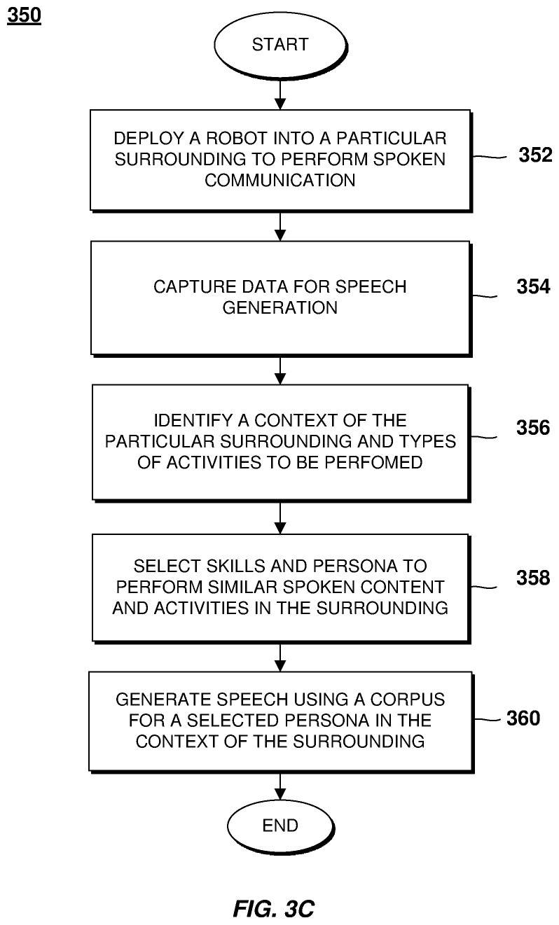

Referring now to FIG. 3, a flowchart illustrating the steps of a computer-implemented method 300 for speech generation based on a device feed is shown, according to an embodiment of the present disclosure.

The method starts at step 302 by receiving first information from a plurality of devices, such as the IoT devices 212 of FIG. 2, available within a surrounding environment associated with one or more users. The first information includes information representative of different human emotions and interactions between the one or more users at different times and different locations. Specifically, the received first information contains data including speech characteristics (e.g., tone, inflection, texture, etc.) that can be associated with the different emotions, times, and locations of the one or more users.

The method continues at step 304 by receiving second information representative of different parameters associated with environmental conditions surrounding a current location of the one or more users at different times. According to an embodiment, the second information can be obtained from the plurality of devices. Particularly, the second information can be obtained from IoT devices available in the current location of the one or more users. Example of the parameters associated with environmental conditions surrounding a location of the one or more users may include room temperature, noise level, humidity level, light intensity, and the like. These parameters can be detected using readily available smart devices such as thermostats, home assistants, light bulbs, etc.

At step 306, the first and second information for each of the different times is combined and analyzed to determine a correlation between different environmental parameters, surrounding context, and human interactions on generated speech and behavior. In some embodiments, third information from external data sources, including virtual reality systems, previously recorded speeches, crowdsource information, and data provided by users, can be received (step 308) and merged with the first and second information to generate combined datasets for each of the different times. The analyzed information is annotated and organized according to the determined correlation at step 310 to generate a plurality of annotated combined datasets for each of the different times, that are subsequently stored in a repository of information such as the historical knowledge base 220 of FIG. 2.

At step 312, the plurality of combined annotated datasets are correlated to create training data that can be processed by a predetermined machine learning model at step 314. Based on the machine learning model, a corpus for robotic use is generated at step 316. At step 318 the training data is analyzed to identify a correlation between a spoken tone associated with a current contextual situation of the one or more users and a level of skills of the one or more users. In response to identifying the correlation, the corpus is updated at step 320. According to an embodiment, the updated corpus matches current environmental parameters, persona, and surrounding context of the one or more users.

Accordingly, the method 300 can be used by robotic systems in numerous situations. FIG. 3C illustrates an exemplary embodiment 350 in which the method 300 is used by a robotic system to generate human-like speech.

Referring now to FIG. 3C, at step 352 a robot or robotic system (not shown) is deployed into a particular surrounding to perform spoken communication with a person located in the particular surrounding. Specifically, the robot may be deployed to a particular location to perform a rescue operation during which spoken communication can occur with the person to be rescued. At step 354, the robot may capture data from IoT devices available in the particular surrounding. In cases in which IoT devices are not available, the robot may be instructed to deploy a plurality of mobile sensors to capture data from the particular surrounding for speech generation.

At step 356, in response to receiving data from the available IoT devices and/or the plurality of mobile sensors, the robot identifies a context of the particular surrounding, and types of activity to be performed. Based on the identified context of the particular surrounding, and the types of activity to be performed, the robot at step 358 selects skills and persona to perform similar spoken content and to perform activities in the particular surrounding. Finally, at step 360, the robot generates speech using a corpus for a selected persona in the context of the particular surrounding from the historical knowledge base 220 of FIG. 2.

Other implementation of the proposed method 300 may include assessing the impact of certain activities based on a person's changes in speech and emotions. For example, the proposed embodiments can be implemented in an amusement park to create a knowledge base of visitors reactions to a specific attraction or theme that can subsequently be used to improve customer satisfaction and business strategies.

Therefore, embodiments of the present disclosure provide a method, system and computer program product to, among other things, enhance computer-generated speech by leveraging current IoT technology and machine learning techniques in a way such that spoken language is more attuned to the environment in which communication is happening. Specifically, the proposed embodiments can be utilized by robot systems to reproduce more realistic communication that is appropriate to the actual contextual situation. The proposed cognitive method leverages surrounding environmental parameters through the usage of IoT technologies to enable the robotic systems with human-like voice tone, spoken texture, and emotion during a conversation. By implementing the proposed embodiments, the robotic systems may also be capable of analyzing the contextual situation and IoT feeds from the surroundings to identify the type of skills and persona required to perform an activity in the particular contextual situation.

Referring now to FIG. 4, a block diagram of components of client computer 102 and server computer 114 of networked computer environment 100 of FIG. 1 is shown, according to an embodiment of the present disclosure. It should be appreciated that FIG. 4 provides only an illustration of one implementation and does not imply any limitations regarding the environments in which different embodiments may be implemented. Many modifications to the depicted environment may be made.

Client computer 102 and server computer 114 may include one or more processors 402, one or more computer-readable RAMs 404, one or more computer-readable ROMs 406, one or more computer readable storage media 408, device drivers 412, read/write drive or interface 414, network adapter or interface 416, all interconnected over a communications fabric 418. Communications fabric 418 may be implemented with any architecture designed for passing data and/or control information between processors (such as microprocessors, communications and network processors, etc.), system memory, peripheral devices, and any other hardware components within a system.

One or more operating systems 410, and one or more application programs 411 are stored on one or more of the computer readable storage media 408 for execution by one or more of the processors 402 via one or more of the respective RAMs 404 (which typically include cache memory). In the illustrated embodiment, each of the computer readable storage media 408 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Client computer 102 and server computer 114 may also include a R/W drive or interface 414 to read from and write to one or more portable computer readable storage media 426. Application programs 411 on client computer 102 and server computer 114 may be stored on one or more of the portable computer readable storage media 426, read via the respective R/W drive or interface 414 and loaded into the respective computer readable storage media 408.

Client computer 102 and server computer 114 may also include a network adapter or interface 416, such as a TCP/IP adapter card or wireless communication adapter (such as a 4G wireless communication adapter using OFDMA technology) for connection to a network 428. Application programs 411 on client computer 102 and server computer 114 may be downloaded to the computing device from an external computer or external storage device via a network (for example, the Internet, a local area network or other wide area network or wireless network) and network adapter or interface 416. From the network adapter or interface 416, the programs may be loaded onto computer readable storage media 408. The network may comprise copper wires, optical fibers, wireless transmission, routers, firewalls, switches, gateway computers and/or edge servers.

Client computer 102 and server computer 114 may also include a display screen 420, a keyboard or keypad 422, and a computer mouse or touchpad 424. Device drivers 412 interface to display screen 420 for imaging, to keyboard or keypad 422, to computer mouse or touchpad 424, and/or to display screen 420 for pressure sensing of alphanumeric character entry and user selections. The device drivers 412, R/W drive or interface 414 and network adapter or interface 416 may include hardware and software (stored on computer readable storage media 408 and/or ROM 406).

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

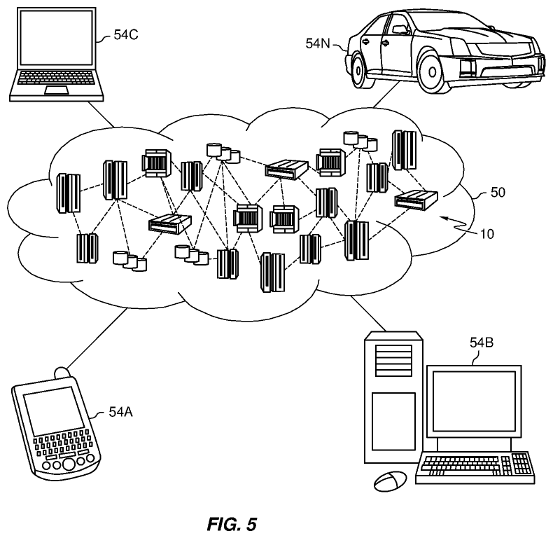

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

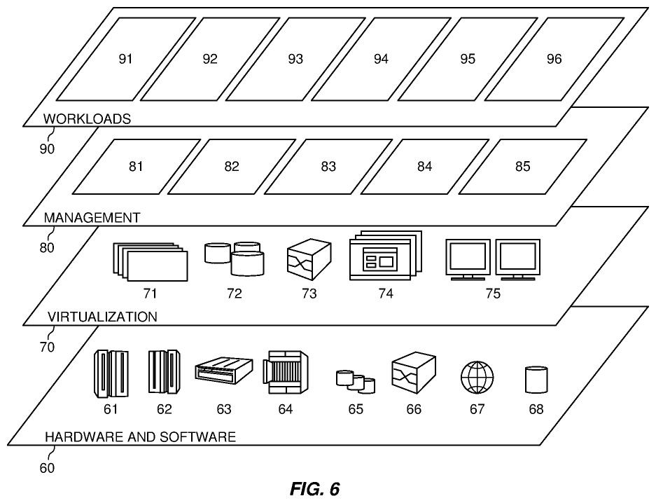

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and system for speech generation 96.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While steps of the disclosed method and components of the disclosed systems and environments have been sequentially or serially identified using numbers and letters, such numbering or lettering is not an indication that such steps must be performed in the order recited, and is merely provided to facilitate clear referencing of the method's steps. Furthermore, steps of the method may be performed in parallel to perform their described functionality.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for speech generation, comprising:
generating a corpus for robotic use by:
receiving, by one or more processors, first information representative of user's speech in different locations at different times;
receiving, by the one or more processors, second information representative of environmental conditions of the different locations at the different times;
combining, by the one or more processors, the first information and the second information of corresponding different locations for each of the different times;
in response to receiving third information from external data sources, generating, by the one or more processors, a plurality of annotated combined datasets comprising the first information, the second information, and the third information for each of the different times in a repository;
correlating, by the one or more processors, the plurality of annotated combined datasets to create training data; and
processing, by the one or more processors, the training data using a predetermined machine learning model;
analyzing, by the one or more processors, the training data to identify a correlation among spoken tone associated with a contextual situation based on skills of a user; and
updating, by the one or more processors, the corpus with the identified correlation.

2. The method of claim 1, wherein the first information and the second information is received from at least one Internet of Things (IoT) device available in a current location of the user.

3. The method of claim 2, wherein the at least one IoT device comprises a plurality of sensors capable of identifying a voice tone and spoken texture of the user representative of different emotions and human interaction.

4. The method of claim 1, wherein analyzing the training data further comprises:
based on the first information, second information, and third information, identifying, by the one or more processors, an influence of surrounding factors on spoken tone and emotions to generate the speech considering different environmental conditions and skills of the user.

5. The method of claim 1, wherein the third information from external data sources comprises at least one of a recorded speech, speech data from virtual reality systems, crowdsource data, and data provided by the user.

6. The method of claim 1, further comprising:
in response to deploying a robot into a particular surrounding to perform spoken communication with the user, instructing, by the one or more processors, the robot to deploy a plurality of mobile sensors to capture data for speech generation.

7. The method of claim 6, further comprising:
in response to receiving data from the plurality of mobile sensors by the robot, instructing, by the one or more processors, the robot to identify a context of the particular surrounding, and types of activity to be performed;
in response to receiving the context of the particular surrounding, and the types of activity to be performed, instructing, by the one or more processors, the robot to select skills and persona to perform similar spoken content and to perform activities in the particular surrounding; and
instructing, by the one or more processors, the robot to generate a speech using the corpus for a selected persona in the context of the particular surrounding.

8. A computer system for speech generation, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
generating a corpus for robotic use by:
receiving, by one or more processors, first information representative of user's speech in different locations at different times;
receiving, by the one or more processors, second information representative of environmental conditions of the different locations at the different times;
combining, by the one or more processors, the first information and the second information of corresponding different locations for each of the different times;
in response to receiving third information from external data sources, generating, by the one or more processors, a plurality of annotated combined datasets comprising the first information, the second information, and the third information for each of the different times in a repository;
correlating, by the one or more processors, the plurality of annotated combined datasets to create training data; and
processing, by the one or more processors, the training data using a predetermined machine learning model;
analyzing, by the one or more processors, the training data to identify a correlation among spoken tone associated with a contextual situation based on skills of a user; and
updating, by the one or more processors, the corpus with the identified correlation.

9. The computer system of claim 8, wherein the first information and the second information is received from at least one Internet of Things (IoT) device available in a current location of the user.

10. The computer system of claim 9, wherein the at least one IoT device comprises a plurality of sensors capable of identifying a voice tone and spoken texture of the user representative of different emotions and human interaction.

11. The computer system of claim 8, wherein analyzing the training data further comprises:
based on the first information, second information, and third information, identifying, by the one or more processors, an influence of surrounding factors on spoken tone and emotions to generate the speech considering different environmental conditions and skills of the user.

12. The computer system of claim 8, wherein the third information from external data sources comprises at least one of a recorded speech, speech data from virtual reality systems, crowdsource data, and data provided by the user.

13. The computer system of claim 8, further comprising:
in response to deploying a robot into a particular surrounding to perform spoken communication with the user, instructing, by the one or more processors, the robot to deploy a plurality of mobile sensors to capture data for speech generation.

14. The computer system of claim 13, further comprising:
in response to receiving data from the plurality of mobile sensors by the robot, instructing, by the one or more processors, the robot to identify a context of the particular surrounding, and types of activity to be performed;
in response to receiving the context of the particular surrounding, and the types of activity to be performed, instructing, by the one or more processors, the robot to select skills and persona to perform similar spoken content and to perform activities in the particular surrounding; and
instructing, by the one or more processors, the robot to generate a speech using the corpus for a selected persona in the context of the particular surrounding.

15. A computer program product for speech generation, comprising:
one or more computer readable storage media, and program instructions collectively stored on the one or more computer readable storage media, the program instructions comprising:
generating a corpus for robotic use by:
receiving, by one or more processors, first information representative of user's speech in different locations at different times;
receiving, by the one or more processors, second information representative of environmental conditions of the different locations at the different times;
combining, by the one or more processors, the first information and the second information of corresponding different locations for each of the different times;
in response to receiving third information from external data sources, generating, by the one or more processors, a plurality of annotated combined datasets comprising the first information, the second information, and the third information for each of the different times in a repository;
correlating, by the one or more processors, the plurality of annotated combined datasets to create training data; and
processing, by the one or more processors, the training data using a predetermined machine learning model;
analyzing, by the one or more processors, the training data to identify a correlation among spoken tone associated with a contextual situation based on skills of a user; and
updating, by the one or more processors, the corpus with the identified correlation.

16. The computer program product of claim 15, wherein the first information and the second information is received from at least one Internet of Things (IoT) device available in a current location of the user.

17. The computer program product of claim 16, wherein the at least one IoT device comprises a plurality of sensors capable of identifying a voice tone and spoken texture of the user representative of different emotions and human interaction.

18. The computer program product of claim 15, wherein analyzing the training data further comprises:
based on the first information, second information, and third information, identifying, by the one or more processors, an influence of surrounding factors on spoken tone and emotions to generate the speech considering different environmental conditions and skills of the user.

19. The computer program product of claim 15, wherein the third information from external data sources comprises at least one of a recorded speech, speech data from virtual reality systems, crowdsource data, and data provided by the user.

20. The computer program product of claim 15, further comprising:
in response to deploying a robot into a particular surrounding to perform spoken communication with the user, instructing, by the one or more processors, the robot to deploy a plurality of mobile sensors to capture data for speech generation;
in response to receiving data from the plurality of mobile sensors by the robot, instructing, by the one or more processors, the robot to identify a context of the particular surrounding, and types of activity to be performed;
in response to receiving the context of the particular surrounding, and the types of activity to be performed, instructing, by the one or more processors, the robot to select skills and persona to perform similar spoken content and to perform activities in the particular surrounding; and
instructing, by the one or more processors, the robot to generate a speech using the corpus for a selected persona in the context of the particular surrounding.
